(19) United States
(12) Patent Application Publication
(10) Pub. No.: US 2002/0166460 A1
(43) Pub. Date: Nov. 14, 2002

(54) Apparatus and method of converting a barbecue grill into a smoker device

(76) Inventor: Gerald Michael O'Shea, St.Paul, MN (US)

Correspondence Address: Michael A. Mochinski, Attorney at Law, Suite 514, 3300 Bass Lake Road, Brooklyn Center, MN, 55429, US

(21) Appl. No.: 10/142,536

(22) Filed: May 8, 2002

Related U.S. Application Data
(60) Provisional application No. 60/289,875, filed on May 9, 2001.

(51) Int. Cl. A47J 9/00; A23B 4/03

(52) U.S. Cl. 99/482; 99/450

(57) ABSTRACT

A smoke producing device adaptably configured for use in either a gas and electric barbecue grill having a plurality of heat diffusers, heat bars or plates, or sear bars (collectively referred to hereinafter as the “heat distribution bar”) principally serving as means to distribute heat and aid in preventing flare-ups within a grilling compartment, the smoker device substantially comprising a rectangular-shaped receptacle having a pair of longitudinal walls positioned perpendicular and integrally attached to a pair of end walls and an inwardly-protruding channel situated between a pair of bottom plate members and extending lengthwise thereabout to form a pair of legs for engaging the heat distribution bar. A detachable top having a plurality of elongate openings allows venting of accumulated smoke as heat is applied to a smoke-producing material contained within the rectangular-shaped receptacle.

### CROSS-REFERENCE TO RELATED APPLICATIONS

This application claims the benefit of U.S. Provisional Application No. 60/289,875 filed May 9, 2001, which is incorporated herein by this reference.

### FIELD OF THE INVENTION

The present invention relates to an apparatus and method of converting a conventional barbecue gas grill into a smoker device for flavoring foods and the like. More particularly, the present invention relates to an improved smoker device that is adaptably configured for use with either a conventional gas or electric grill of the type generally comprising a sear bar, heat diffuser shield, or a heat bar as means to distribute heat to the cooking surface and/or prevent the occurrence of flare-ups at and near a cooking surface.

### BACKGROUND OF THE INVENTION

Barbecuing on gas grills and the like has grown substantially over the years due to the progressive development of the technology and the versatility it affords the consumer in cooking foods apart from an indoor environment. Owners and users of outdoor gas grills are continually seeking barbecue products that will enhance their outdoor cooking experience. One such product incorporates the combined use of containerized woodchips and heat applied thereto to impart a degree of smoke flavor to the food. Due to the inherent problems associated with ash residues and lengthy heating times, many consumers have departed from the typical charcoal or wood burning grill types, which were commonly used to flavor food with smoke, and opted for the conventional gas or electric barbecue grill. The conventional gas grill will generally include components for heat generation, a cooking surface, and an enclosure. Rarely will the conventional gas grill include components and attachments for the generation of smoke to enhance or flavor the food as was once easily made possible with the conventional charcoal grill. Therefore, in order to satisfy one's desire for smoke-flavored food, a receptacle of some sort to contain and hold the woodchips and the like must be fitted in some manner within or near the burner assembly to initiate the smoldering of woodchips and the like to commence the process of flavoring food with smoke.

A number of such devices are well known in the art and are readily available at commercial outlets where gas grills and the like are sold and purchased by the consumer. However, most, if not all, devices for smoking woodchips and the like comprise a rectangular configuration and a flat bottom for sitting atop of or suspending from the grilling surface or a briquette-holding grate. Because of this geometric configuration, many smoker attachments cannot be positioned at an optimum location within the grilling compartment without undue modification of the gas grill structure. It is well known to those most versed in smoking food using barbecue gas grills that the optimum location of the smoker device or attachment is near the burner assembly, but not so close as to promote firing or flaming of the woodchips and the like within the grilling compartment.

As a means to generate and distribute heat to the cooking surface, the conventional gas grill generally comprises in part a burner assembly and either a heat diffuser shield, heat bar or searing bar extending lengthwise about and substantially below the cooking or grilling surface. Generally, the heat diffuser shield, heat bar or sear bar will come in a variety of shapes and configurations to enhance the distribution of heat within the grilling compartment. In some instances, a briquette-holding grate to hold and suspend lava rock or ceramic briquettes above the burner assembly may be used in the alternative to distribute heat and minimize the potential of flare-ups within the grilling compartment. As a result of these proprietary designs of the heat diffuser shield, heat bar or sear bar, most smoker attachments will fail to perform adequately or most efficiently because of their inability to be fitted or placed at the optimum location within the grilling compartment, most particularly near the grill's burner.

Many forms of attachments for smoking woodchips and the like have been developed and designed in attempt to provide a satisfactory solution to the problem. However, many smoker attachments are designed with the understanding that the attachment will be used exclusively with or be directed for use with a certain brand, type or model of barbecue grill, as can be seen in U.S. Pat. No. 5,167,183 issued to Schlosser et al. Schlosser depicts a smoker attachment having openings configured geometrically to correspond to the configuration of the sear bar. In U.S. Pat. No. 6,102,028, also issued to Schlosser et al., the smoker attachment disclosed therein is purposefully designed for use with a plurality of sear bars having a corresponding geometric configuration.

In some instances, the relevant body of art teaches the use of receptacles having a plurality of perforations to enhance air infiltration for ample burning of the woodchips and the like, such as can be seen in the above-cited references. Although these designs or geometric configurations promote rapid ignition of the woodchips, they generally allow for too much air to enter into the receptacle causing a chimney effect in which updrafted air accelerates burning of the wood without allowing the wood to smolder to produce smoke for a sustained period of time.

A chief advantage of the present invention over previous efforts in providing devices to enhance the flavor of food with smoke is that the installation is simple, can adequately contain and efficiently burn woodchips and the like for the production of smoke to flavorize foods for sustained periods of time, and can be readily used with a variety of gas or electric grills, regardless of the geometric configuration of the heat diffuser shield, heating bar, and sear bar. For those barbecue grills having absent a heat diffuser shield, heating bar, and sear bar to support a smoker device or attachment, the present invention can be readily placed onto and over the briquette-holding grate to achieve equal utility in producing smoke to flavor foods. In fact, the present invention has been tested and used with a variety of gas grill types having varying heat diffuser shield designs without undue difficulty or modification thereto.

### BRIEF SUMMARY OF THE INVENTION

In order to overcome the numerous drawbacks apparent in the prior art, an improved device for generating and producing smoke within the grilling compartment of barbecue grills has been devised.

It is thus an object of the present invention to provide a low cost non-complicated smoker device which may be reliably and easily usable with a variety of gas and electric grill types.

It is another object of the present invention to provide a smoker device that is geometrically adaptable to fit a wide variety of heat diffuser shield, heating bar, and sear bar designs without undue difficulty or modification of components comprising the grilling compartment.

It is another object of the present invention to provide a smoker device that can equally accommodate liquids as well as woodchips to flavor foods with smoke.

It is another object of the present invention to provide a smoker device that can promote and assist in supplementing the distribution of heat within the grilling compartment to eliminate cold spots therein for uniform cooking and smoking of foods.

It is another object of the present invention to provide a smoker device that adequately conducts and transfers heat to the woodchips and the like to provide ample smoke to flavor foods most efficiently.

It is yet another object of the present invention to provide a smoker device that is economical, durable, and fully effective in performing its intended functions.

In accordance with the present invention, a smoker device has been devised for use with either a gas or electric grill generally of the type comprising a grilling compartment having a burner assembly situated therein for supplying heat to a cooking surface and either a heat diffuser shield, heat bar or sear bar (collectively referred to hereinafter as the “heat distribution bar”) extending longitudinally about the grilling compartment, below the cooking surface, insofar to uniformly distribute heat within and about the grilling compartment and to aid in preventing flare-ups at the cooking surface. The smoker device generally comprises a rectangular-shaped receptacle having a pair of longitudinal walls of equal length and a pair of end walls also of equal length. The longitudinal walls are positioned parallel to one another and are integrally attached to and separated apart from one another by the end walls. Each of the end walls comprises a cutout located at the midsection thereof and a pair of opposing ends that taper inward toward the bottom thereof to allow the longitudinal walls to be inwardly pitched. An inwardly-protruding channel situated between a pair of bottom plate members integrally attached to the longitudinal walls and end walls and extending lengthwise thereabout substantially engages the heat distribution bar for maximum heat transfer to the woodchips and the like contained within the rectangular-shaped receptacle. A detachable top having a plurality of elongate openings serve as a passageway to vent smoke as it is generated by the application of heat to the woodchips and to view the contents contained within the rectangular-shaped receptacle. The detachable top further comprises an underside surface having a plurality of elongate rims fixedly attached thereto to stabilize and prevent lateral movement of the detachable top during repositioning of the smoker device within the grilling compartment.

Other objects, features, and advantages of the present invention will become apparent in the following detailed description of the preferred embodiments thereof when read in conjunction with the accompanying drawings in which like reference numerals depict the same parts in the various views.

### BRIEF DESCRIPTION OF THE SEVERAL VIEWS OF THE DRAWINGS

A preferred embodiment of the present invention will now be described by way of example with reference to the accompanying drawings, in which:

FIG. 1 is a partial perspective view of the preferred embodiment of the smoker device illustrating its positioning atop of a heat distribution bar contained within a grilling compartment of a typical barbecue grill;

FIG. 2 is a perspective view of the preferred embodiment of the smoker device;

FIG. 3 is a side perspective view of the preferred embodiment of the smoker device;

FIG. 4 is an end perspective view of the preferred embodiment of the smoker device;

FIG. 5 is a top perspective view of the preferred embodiment of the smoker device illustrating the geometric configuration of an inwardly-protruding channel positioned within a rectangular-shaped receptacle;

FIG. 6 is a bottom perspective view of the preferred embodiment of the smoker device illustrating the geometric configuration of a pair of bottom plate members; and

FIG. 7 is a top view of the preferred embodiment of the smoker device illustrating an underside surface of a detachable top.

### DETAILED DESCRIPTION OF THE INVENTION

While this invention is susceptible of being embodied in many different forms, preferred embodiment of the invention is shown in the drawings and described in detail hereinafter with the understanding that the present disclosure is to be considered to exemplify the principles of the present invention and is not intended to limit the invention to the embodiment illustrated. The present invention has particular utility as a device capable of storing woodchips and the like for the production of smoke as heat is applied thereto.

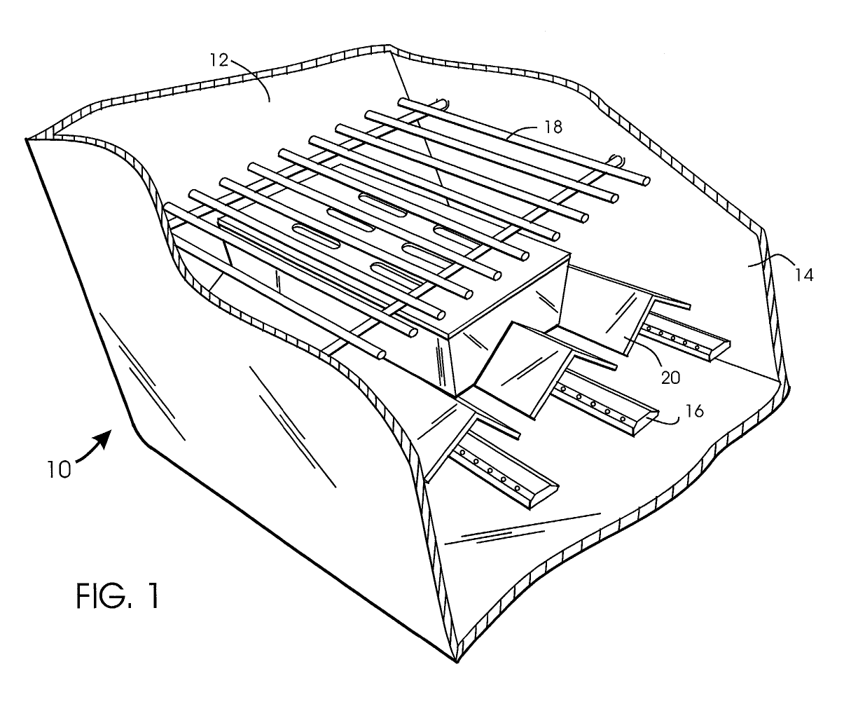

Referring to FIG. 1, there is shown generally at 10 a conventional gas grill having a grilling compartment 12 comprised of a lower grill housing 14; a burner assembly 16 running longitudinally about the lower grill housing, below a cooking surface 18; and either a heat diffuser, heat bar or plate, or sear bar 20 (collectively referred to hereinafter as the “heat distribution bar”) for distributing heat within and about the grilling compartment and to aid in mitigating flare-ups at and near the cooking surface.

As best illustrated in FIG. 1, the heat distribution bar is generally made from a metal-bearing material, such as carbon steel, iron, aluminum, or an equivalent material having the capacity to conduct and transfer heat within grilling compartment. In general, the grilling compartment houses a plurality of equally-spaced heat distribution bars 20 that extend parallel to one another and traverse the length or width of the lower grill housing 14, generally corresponding to the length of the burner assembly. The orientation of the heat distribution bar and burner assembly is illustrated in FIG. 1 as being placed longitudinally about the grilling compartment for purposes of illustration and explanation of their function relative to the present invention. The heat distribution bar may comprise a variety of cross sectional shapes, such as an inverted “V,” oval, or similar shape having an ample surface area available for distributing heat within the grilling compartment. Although the present invention can be used with a variety of heat distribution bar shapes generally made part of the barbecue grilling unit, a heat distribution bar having the shape of an inverted “V” will be used hereinafter to describe its cooperative features and interaction with that of the present invention, as best shown in FIG. 1.

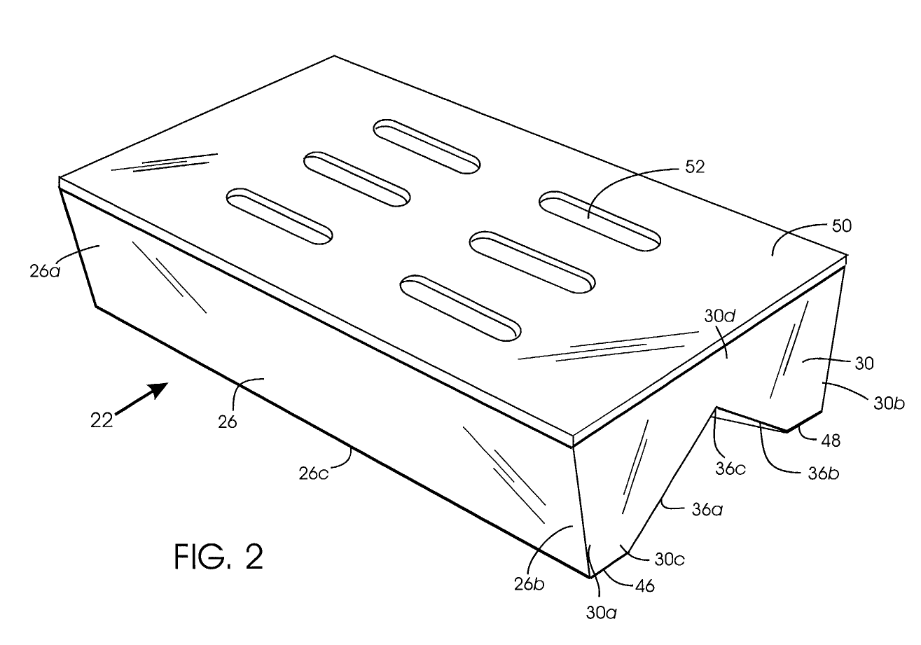

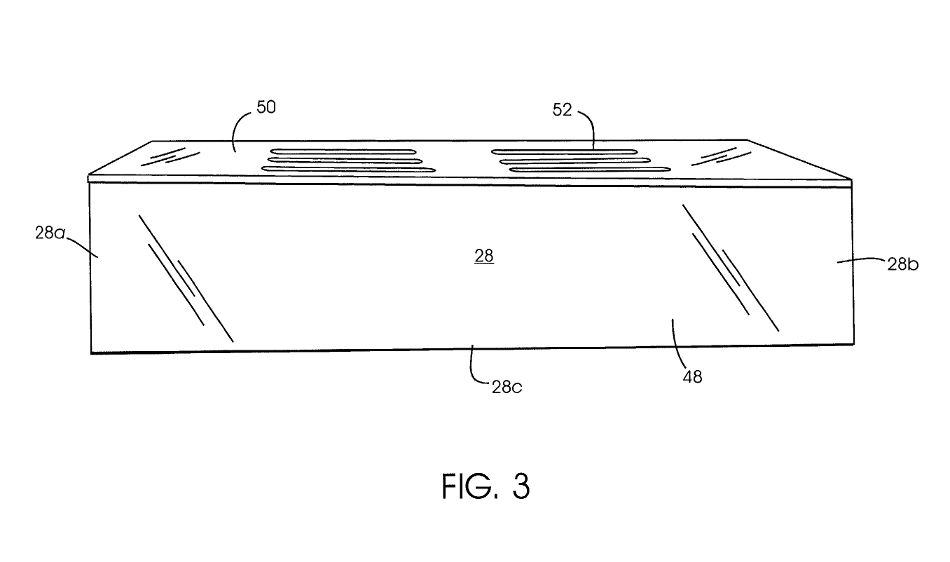

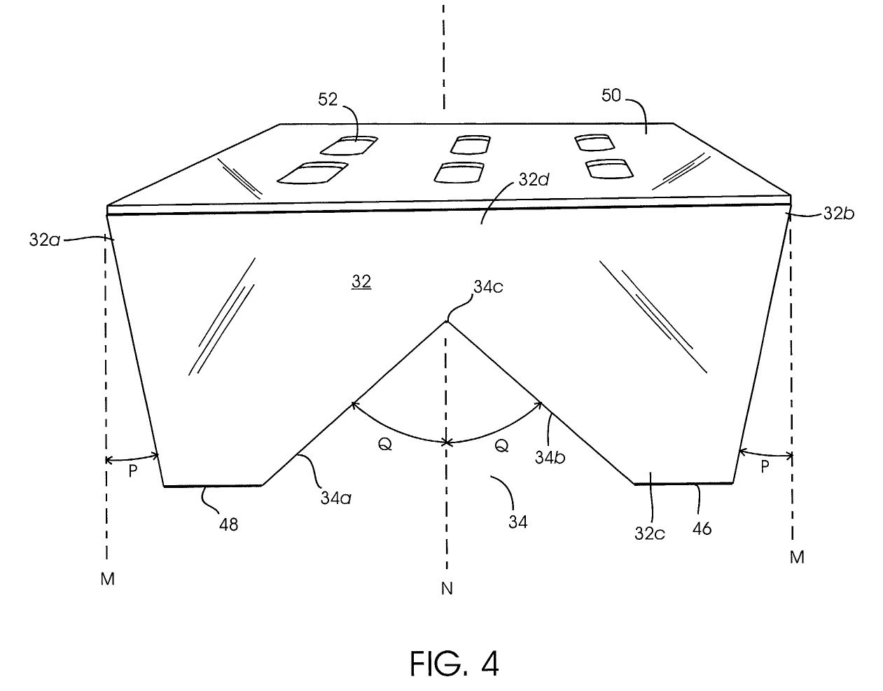

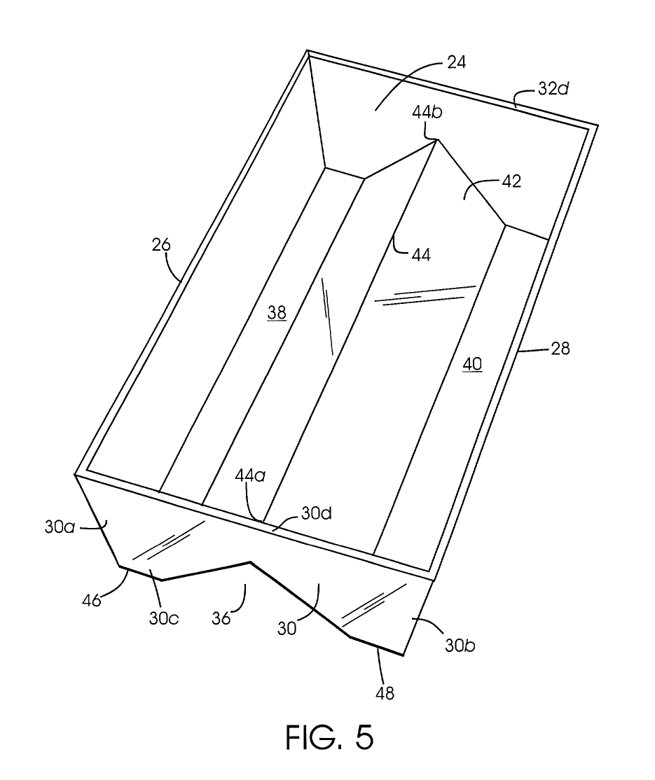

The preferred embodiment of the smoker device, shown generally at 22 in FIG. 2, comprises a rectangular-shaped receptacle 24 having a pair of longitudinal walls 26, 28 and a pair of end walls 30, 32, which are preferably shorter than the longitudinal walls. As depicted in FIGS. 3 and 5, the longitudinal walls 26, 28, each comprising a pair of opposing ends 26a, 26b, 28a, 28b and a bottom 26c, 28c, respectively, are substantially rectangular in shape and are fixedly attached to and positioned apart from one another by the end walls 30, 32 that extend parallel to one another. Each of the end walls 30, 32 further comprise a pair of opposing ends 30a, 30b, 32a, 32b, a bottom 30c, 32c, and a top 30d, 32d, respectively. In the preferred embodiment, the bottom of the end wall is of a shorter length than the top, which substantially establishes the opposing ends 30a, 30b, 32a, 32b to be inwardly pitched, generally 10° from line M extending normal to the top 30d, 32d of the end wall 30, 32, as illustrated along line P in FIG. 4. Located substantially at the midsection of each of the end walls 30, 32 is a cutout 34, 36 preferably shaped as an inverted “V” so as to fit over and about the geometric configuration of the heat distribution bar 20. However, other geometric configurations may be used and would generally depend on the cross sectional configuration of the heat distribution bar. Each cutout 34, 36 is principally formed and shaped by a pair of inclined sides 34a, 34b, 36a, 36b each being downwardly pitched from a common point defined as an apex 34c, 36c, particularly being located at the midsection of each of the end walls 30, 32. Preferably, each of the two inclined sides is outwardly pitched by approximately 47.5° from a vertical axis extending through the apex 34c, 36c, as illustrated along line Q with reference to line N in FIG. 4, and comprise lengths generally corresponding to the linear cross sectional dimensioning of the heat distribution bar of approximately 1-¾″. The apex 34c, 36c preferably lays approximately 11/16″ below the top of each of the end walls 30, 32 to prevent the occurrence of breakage thereat given the short distance between the apex and the top 30d, 32d of the end wall and the particular characteristics of cast iron used in fabricating the smoker device.

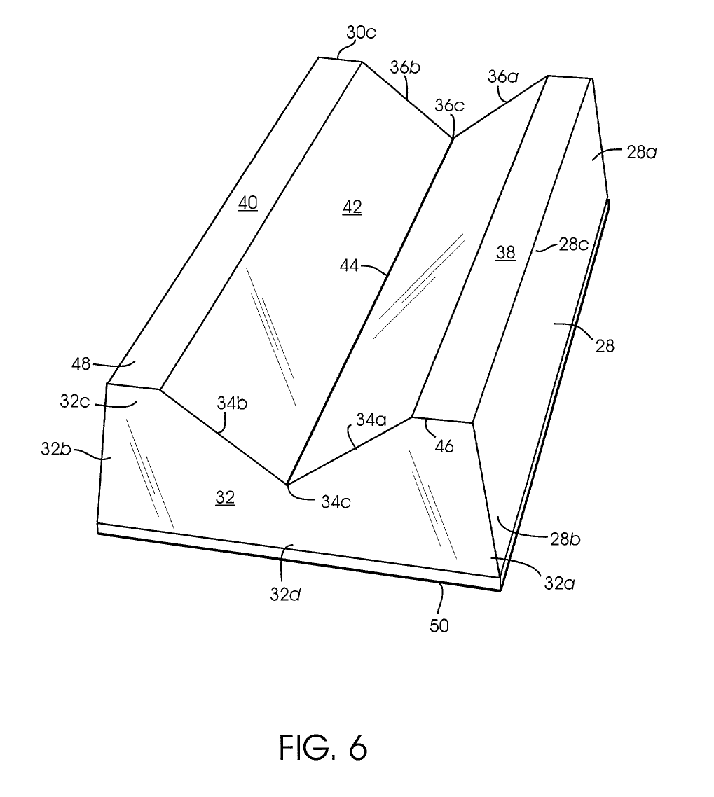

As shown in FIG. 5, the opposing ends 26a, 26b, 28a, 28b of the longitudinal walls are fixedly attached to the opposing ends 30a, 30b, 32a, 32b of the end walls, generally forming the rectangular-shaped receptacle 24 as noticeably viewed from the top. Fixedly attached to the bottoms 26c, 28c, 30c, 32c of the longitudinal walls 26, 28 and end walls 30, 32 is a pair of bottom plate members 38, 40 that extend lengthwise about the smoker device 22. An inwardly-protruding channel 42 situated between the bottom plate members generally extends longitudinally therewith and terminates at and corresponds to the geometric configuration of the cutouts 34, 36 present at the midsection of each of the end walls 30, 32. The inwardly-protruding channel generally comprises a longitudinal apex 44 having ends 44a, 44b substantially established at apexes 34c, 36c included as part of the cutouts 34, 36. The collective geometric configuration of the inwardly-protruding channel and bottom plate members substantially allows ample surface contact with the heat distribution bar for maximum transfer of heat to the woodchips and the like residing within the rectangular-shaped receptacle 24. As illustrated in FIG. 6, a pair of legs 46, 48, formed by the collective arrangement of the inwardly-protruding channel and bottom plate members, serve as effective means to stabilize the smoker device 22 atop a flat surface, most noticeably needed if the grilling compartment cannot accommodate the smoker device or is absent of any heat distribution bar. For instance, height limitations of the cooking surface 18 relative to the placement of the heat distribution bar 20 may inhibit optimum positioning of the smoker device atop of the heat distribution bar, near the burner assembly 16. In which case, it would be more desirable or practical to place the smoker device atop of the cooking surface 18. Similarly, a barbecue grill having absent a heat distribution bar may require placing the smoker device 22 on a flat briquette-holding grate of the type generally included in a conventional barbecue grill. In addition to the above-described function, the legs 46, 48 may adequately allow the smoker device to be situated between the heat distribution bars and/or walls of the lower grilling housing 14 for additional surface area in contact with heat-conducting materials, as depicted in FIG. 1. This positioning results in an opportunity for greater heat transfer to the woodchips and the like insofar to efficiently produce smoke to flavor foods for a sustained period of time.

In the preferred embodiment of the present invention, the longitudinal walls 26, 28 as well as the end walls 30, 32 are integrally formed together with the bottom plate members 38, 40 and inwardly-protruding channel 42 and are collectively fabricated from cast iron to eliminate any possibility of releasing contents (e.g., ash residues from flavoring liquids and solids) from the rectangular-shaped receptacle 24 into the burner assembly 16 and causing damage thereto due to the presence of corrosive-causing agents generally generated during and associated with the decomposition of woodchips and the like. Although other materials such as aluminum, steel or other materials having the capacity to conduct heat can be used for the longitudinal and end walls and bottom plate member, cast iron is desirable over other known conducting materials for its ability to be easily molded to the desired geometric configuration, availability in the manufacturing sector generally at a lesser cost than comparable conductive-bearing materials, ability to retain and uniformly distribute heat throughout the grilling compartment to prevent cold spots therein and rectangular-shaped receptacle 24 without undue burning or igniting of the woodchips and the like residing therein, and moderate ability to withstand the corrosive nature of ash residues over sustained periods of decomposition.

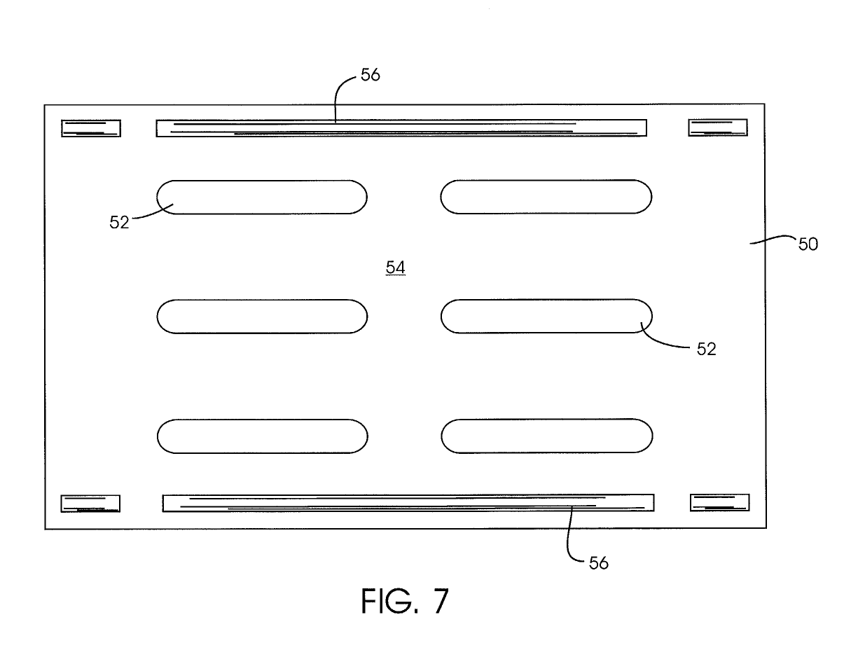

As shown in FIG. 3, a detachable top 50 as used to sufficiently cover the contents contained within the rectangular-shaped receptacle comprises a plurality of openings 52 extending therethrough for passage of smoke as it is generated during use of the smoker device 22. The detachable top is preferably made from equivalent conducting-bearing materials described and used for the integrally formed rectangular-shaped receptacle. The openings 52 principally serve to vent the accumulation of smoke as it is generated by the application of heat to the woodchips residing within the rectangular-shaped receptacle defined by the longitudinal and end walls, bottom plate members, and inwardly-protruding channel. In addition to its venting feature, the openings allow for full and complete access to the rectangular-shaped receptacle 24 without having to remove the entire smoker device 22 from the grilling compartment 12. This feature is particularly important in determining the need to replenish the rectangular-shaped receptacle with woodchips and the like as they deplete over a period of time during operation of the smoker device. Preferably and as illustrated in FIG. 7, the detachable top comprises six openings, with each having an elongate shape.

The detachable top further comprises an underside surface 54 having a plurality of elongate rims 56 fixedly attached thereto to stabilize and prevent lateral movement of the detachable top 50 during repositioning of the smoker device 22 within the grilling compartment 12. As illustrated in FIG. 7, the elongate rims are preferably placed inward from and about the periphery of the detachable top, within a distance that approximates the wall thickness of the longitudinal wall extending upwardly from the bottom plate member.

In a typical operating scenario, the smoker device is preferably placed within the grilling compartment, below the grilling surface, and would comprise of the following steps to ensure adequate production of smoke: exposing those components generally comprising the grilling compartment 12, such as the heat distribution bar 20 situated below the cooking surface 18, generally adjacent to the burner assembly 16; removing the cooking surface to gain full and complete access to the heat distribution bar 20 running lengthwise about the lower grill housing 14; placing woodchips and the like into the rectangular-shaped receptacle 24 and filling it to capacity, preferably an amount that substantially covers the longitudinal apex 44 of the inwardly-protruding channel 42 present within the rectangular-shaped receptacle 24; fitting the detachable top 50 onto the longitudinal walls and end walls so as to substantially enclose the rectangular-shaped receptacle; positioning the legs 46, 48 between the heat distribution bars insofar to allow the inwardly-protruding channel 42 to substantially engage a heat distribution bar for maximum heat transfer to the contents contained within the rectangular-shaped receptacle 24; igniting the burner assembly 16 generally made part of the barbecue grill insofar to supply heat to the heat distribution bar via convection; and allowing a sufficient amount of time to raise the temperature of the heat distribution bar insofar to transfer heat via conduction to the inwardly-protruding channel 42 generally made from a conductive-bearing material.

It is obvious that the smoker device hereinbefore described can be used with a variety of barbecue grills having a heat distribution bar or bars for distributing heat throughout the grilling compartment.

It can be seen from the foregoing that there is provided in accordance with this invention a simple and easily operated smoker device, which is particularly suitable for use in a conventional gas or electric grill having one or more heat distribution bars. The device is appreciably inexpensive to manufacture and can be sold at a nominal price. Furthermore, the smoker device 22 is adaptable for use with heat distribution bars 20 of various shapes and configuration without undue modification thereto or without alteration of the grilling compartment 12. Also, an economical approach has been disclosed for manufacturing the components comprising the rectangular-shaped receptacle 24 from a single casting mold, which correspondingly permits inexpensive manufacture of the smoker device.

It is obvious that the smoker device may be fabricated by other methods than that disclosed and that smoker device can be made from a variety of metal-bearing materials, providing such materials possesses the capacity to conduct and transfer heat to the rectangular-shaped receptacle 24 for efficient production of smoke insofar to enhance the flavoring of foods and ability to withstand the corrosive nature of ash residues as they are generated upon the decomposition of woodchips and the like.

While there has been shown and described a particular embodiment of the invention, it will be obvious to those skilled in the art that various changes and alterations can be made therein without departing from the invention and, therefore, it is aimed in the appended claims to cover all such changes and alterations as fall within the true spirit and scope of the invention.

What is claimed is:

1. A smoker device for use with a conventional barbecue grill having heat distribution bars and a cooking surface suitably configured thereabove to support a cookable food, said smoker device comprising, in combination:
a rectangular-shaped receptacle for containing a smoke-producing material comprising a pair of longitudinal walls each having a pair of opposing ends and a bottom and a pair of end walls each comprising a pair of opposing ends, a top and a bottom, said longitudinal walls being arranged perpendicular and integrally attached to said end walls at said opposing ends of said end walls and said longitudinal walls, each of said end walls further comprising a cutout having an apex and a pair of inclined sides extending downwardly therefrom toward said bottom of said end wall;
a pair of bottom plate members integrally attached to said bottoms of said longitudinal walls and said end walls; and
an inwardly-protruding channel situated between said bottom plate members and extending lengthwise therewith to form a pair of legs for engaging the heat distribution bar having heat conductive properties.

2. A smoker device as set forth in claim 1, further comprising a detachable top adaptably fitted onto and supported by said longitudinal walls and said end walls in a vertical orientation insofar to enclose said rectangular-shaped receptacle.

3. A smoker device as set forth in claim 2, wherein said detachable top comprises a plurality of openings principally serving as a passageway to vent accumulated smoke produced by the smoke-producing material and to intermittingly view the contents contained within said rectangular-shaped receptacle.

4. A smoker device as set forth in claim 3, wherein each of said openings is of an elongate shape.

5. A smoker device as set forth in claim 2, wherein said detachable top comprises an underside surface having a plurality of elongate rims fixedly attached thereto to serve in stabilizing and mitigating lateral movement of said detachable top during handing of said rectangular-shaped receptacle fittingly equipped with said detachable top.

6. A smoker device as set forth in claim 5, wherein each of said elongate rims is inwardly placed from and about the periphery of said detachable top within a distance that substantially approximates the wall thickness of said longitudinal wall.

7. A smoker device as set forth in claim 1, wherein each of said inclined sides is outwardly pitched approximately 47.5° from an axis extending vertically through said apex and said cutout is substantially shaped as an inverted “V”.

8. A smoker device as set forth in claim 1, wherein said inwardly-protruding channel and said cutout comprises a geometric configuration substantially corresponding to the geometric configuration of the heat distribution bar.

9. A smoker device as set forth in claim 1, wherein each of said inclined sides comprises a length substantially equivalent to 1¾ of an inch.

10. A smoker device as set forth in claim 1, wherein said bottom of said end wall comprises a length shorter than the length of said top of said end wall to substantially permit said opposing end of said end wall to be inwardly pitched near said bottom plate member.

11. A smoker device as set forth in claim 1, wherein said opposing end of said end wall is inwardly pitched at said bottom plate member by approximately 10° from a vertical axis extending normal to said top of said end wall.

12. A smoker device as set forth in claim 1, wherein said inwardly-protruding channel comprises a longitudinal apex extending lengthwise thereabout and having ends substantially terminating at said apexes of said v-shaped cutouts.

13. A smoker device as set forth in claim 1, wherein said rectangular-shaped receptacle is fabricated from a cast iron material having heat conductive characteristics.

14. A smoker device as set forth in claim 1, wherein said apex of said cutout is located approximately 11/16″ from said top of said end wall.

15. A smoker device for use with a conventional barbecue grill having a plurality of heat distribution bars for distributing heat within a grilling compartment and a cooking surface suitably configured therein to support a cookable food, said smoker device comprising, in combination:
a rectangular-shaped receptacle for containing a smoke-producing material comprising a pair of longitudinal walls each having a pair of opposing ends and a bottom and a pair of end walls each comprising a pair of opposing ends, a top and a bottom, said longitudinal walls being arranged perpendicular and integrally attached to said end walls at said opposing ends of said end walls and said longitudinal walls, each of said end walls further comprising a cutout having an apex and a pair of inclined sides extending downwardly therefrom toward said bottom of said end wall;
a pair of bottom plate members integrally attached to said bottoms of said longitudinal walls and said end walls;
an inwardly-protruding channel situated between said bottom plate members and extending lengthwise therewith to form a pair of legs for engaging the heat distribution bar having heat conducting properties; and
a detachable top adaptably fitted onto and supported by said longitudinal walls and said end walls in a vertical orientation insofar to enclose said rectangular-shaped receptacle, said detachable top comprising a plurality of openings principally serving as a passageway to vent accumulated smoke produced by the smoke-producing material and to permit intermittent viewing of the contents contained within said rectangular-shaped receptacle, said detachable top further comprising an underside surface having a plurality of elongate rims fixedly attached thereto to serve in stabilizing and mitigating lateral movement of said detachable top during handing of said rectangular-shaped receptacle fittingly equipped with said detachable top.

16. A smoker device as set forth in claim 15, wherein said inwardly-protruding channel and said cutout comprises a geometric configuration substantially corresponding to the geometric configuration of the heat distribution bar.

17. A smoker device as set forth in claim 15, wherein each of said inclined sides is outwardly pitched approximately 47.5° from an axis extending vertically through said apex of said cutout.

18. A method of converting a barbecue grill having a cooking surface and a plurality of heat distribution bars situated within a grilling compartment into a device substantially capable of generating smoke to flavor foods situated atop of the cooking surface and distributing heat in a uniform manner throughout and within the grilling compartment, said method comprising the steps of:
supplying a rectangular-shaped receptacle for containing a smoke-producing material comprising a pair of longitudinal walls each having a pair of opposing ends and a bottom and a pair of end walls each comprising a pair of opposing ends, a top and a bottom, said longitudinal walls being arranged perpendicular and integrally attached to said end walls at said opposing ends of said end walls and said longitudinal walls, each of said end walls further comprising a cutout having an apex and a pair of inclined sides extending downwardly therefrom toward said bottom of said end wall;
attaching a pair of bottom plate members to said bottoms of said longitudinal walls and said end walls;
configuring an inwardly-protruding channel between said bottom plate members to form a pair of legs for engaging the heat distribution bar having heat conducting properties; and
placing a detachable top onto said longitudinal walls and said end walls insofar to enclose said rectangular-shaped receptacle, said detachable top comprising a plurality of openings principally serving as a passageway to vent accumulated smoke produced by the smoke-producing material and to intermittingly view the contents contained within said rectangular-shaped receptacle.

19. A method as set forth in claim 18, wherein said detachable top comprises an underside surface having a plurality of elongate rims fixedly attached thereto to serve in stabilizing and mitigating lateral movement of said detachable top during handing of said rectangular-shaped receptacle fittingly equipped with said detachable top.

20. A method as set forth in claim 18, wherein said inwardly-protruding channel and said cutout comprise a geometric configuration substantially corresponding to the geometric configuration of the heat distribution bar.
